(19) United States
(12) Patent Application Publication
(10) Pub. No.: US 2026/0274283 A1
(43) Pub. Date: Sep. 17, 2026

(54) APPARATUS FOR CONTROLLING A VEHICLE, A SYSTEM HAVING THE SAME AND A METHOD THEREOF

(71) Applicants: HYUNDAI MOTOR COMPANY, Seoul (KR); KIA CORPORATION, Seoul (KR)

(72) Inventor: Jung Tae Cho, Hwaseong-si (KR)

(73) Assignees: HYUNDAI MOTOR COMPANY, Seoul (KR); KIA CORPORATION, Seoul (KR)

(21) Appl. No.: 19/265,841

(22) Filed: Jul. 10, 2025

(30) Foreign Application Priority Data
Mar. 12, 2025 (KR) 10-2025-0032292

(51) Int. Cl. B60W 50/14; B60W 40/08; B60W 50/00; G06F 8/65

(52) U.S. Cl. CPC B60W 50/14; B60W 40/08; B60W 50/0098; G06F 8/65; B60W 2050/0008; B60W 2050/0083; B60W 2050/146

(57) ABSTRACT

A vehicle control apparatus includes a processor configured to check an over-the-air (OTA) software update and detect that a user experience is selected for an updated function. The processor is also configured to mimic a communication signal transmitted to at least one controller related to the updated function based on the selection and control the at least one controller to operate in a virtual mode using the mimicked communication signal. The at least one controller is configured to receive the mimicked communication signal and operate in the virtual mode under control of the processor.

### CROSS-REFERENCE TO RELATED APPLICATION

This application claims priority to and the benefit of Korean Patent Application No. 10-2025-0032292, filed with on Mar. 12, 2025, the entire contents of which are hereby incorporated herein by reference.

### BACKGROUND

### (a) Technical Field

The present disclosure relates to an autonomous driving control apparatus and an autonomous driving control method, and more particularly, to a technology for updating software of a vehicle controller by wireless communication.

### (b) Description of the Related Art

An intelligent transportation system (ITS) is an integrated transportation system that uses advanced information and communication technology (ICT) to optimize inter motion between transportation infrastructure, vehicles, roads, and users to improve safety, efficiency, and convenience. With the recent development of wireless communication systems, for example, services for smart cities and smart cars are becoming more specific based on 3G, 4G, and 5G communication technologies and IoT-related technologies. Ultra-fast communication, low latency, and large-scale data transmission are enabled through the utilization of technologies such as 5G-Adv, 6G, next-generation communication technologies, IoT security, edge computing, network slicing, energy efficiency, and low-power wide-area (LPWA) communication, which have also made communication between vehicles and external entities like other vehicles and infrastructure commonplace.

To enable the exchange or sharing of communication data with external entities, vehicles are equipped with a communication control unit (CCU) that facilitates real-time interaction between vehicles, allowing them to exchange driving information and evolve toward a method that more efficiently predicts collision risks and road conditions. For example, vehicle-to-everything (V2X) communication is a method of exchanging or sharing traffic-related information with road infrastructure and other vehicles during driving, evolving into a technology where all elements of the road (vehicles and vehicles, vehicles and infrastructure, vehicles and pedestrians, vehicles and networks, etc.) exchange information in real time.

Modern vehicle technology increasingly explore integration with advanced services such as autonomous driving, artificial intelligence (AI), and vehicle-to-everything (V2X) communication. In view of these developments, new approaches are being investigated to support emerging functionalities. As a result, electronic control units (ECUs) may be configured with enhanced structural and functional capabilities to support such systems.

### SUMMARY

Embodiments of the present disclosure provide a vehicle control apparatus and method for performing wireless software update via over the air (OTA).

Embodiments of the present disclosure provide a vehicle control apparatus and method for implementing OTA update change history in a virtual mode.

Embodiments of the present invention provide a vehicle control apparatus and method for transmitting and receiving signals by controlling a collision between CAN signals.

Embodiments of the present disclosure provide a vehicle control apparatus and method for implementing a virtual mode by simulating a CAN signal.

Embodiments of the present invention provide a vehicle control apparatus and method for displaying OTA update change history.

The technical objects of the present disclosure are not limited to the objects mentioned above. Other technical objects not mentioned herein may be more clearly understood by those having ordinary skill in the art from the description of the claims.

According to an embodiment of the present disclosure, a vehicle control apparatus is provided. The vehicle control apparatus includes a processor configured to check an over-the-air (OTA) software update. The processor is also configured to detect that a user experience is selected for an updated function. The processor is further configured to mimic a communication signal transmitted to at least one controller related to the updated function based on the selection. The processor is additionally configured to control the at least one controller to operate in a virtual mode using the mimicked communication signal. The at least one controller is configured to receive the mimicked communication signal and operate in the virtual mode under control of the processor.

In an embodiment of the present disclosure, the processor may be configured to implement a virtual motion implementation logic configured to mimic at least one communication signal among a controller area network (CAN) signal and a CAN flexible data-rate (CAN FD) signal and change a signaling value of the mimicked communication signal.

In an embodiment of the present disclosure, the processor may be configured to set a signaling value of the mimicked signal to a value required to operate in the virtual mode, wherein the value required to operate in the virtual mode is set to a value that adaptively varies based on the updated function.

In an embodiment of the present disclosure, the processor may be configured to transmit a signaling transmission suspension request signal to the at least one controller to suspend transmission of an actual signal corresponding to the mimicked communication signal.

In an embodiment of the present disclosure, the processor may be configured to control at least one controller, wherein the at least one controller may suspend transmission of the actual signal upon receiving the signaling transmission suspension request signal.

In an embodiment of the present disclosure, the virtual motion implementation logic may be configured to generate an output request signal based on the mimicked signal and an input signal of another controller, and transmit the generated output request signal to an output processor to control display of a motion result of the virtual mode.

In an embodiment of the present disclosure, the virtual operation implementation logic may be configured to receive a feedback signal (SF) regarding a motion result of the virtual mode from the output processor.

In an embodiment of the present disclosure, the vehicle control apparatus may further include a communication gateway controller configured to perform data transmission and a routing motion of a control period including the at least one controller, wherein the routing motion includes a protocol conversion motion for transmitting data of a specific channel to another channel.

In an embodiment of the present disclosure, the processor may be configured to control the ate least one controller to operate in the virtual mode in based on user input provided via switch manipulation or screen touch.

In an embodiment of the present disclosure, the processor may be configured to check a pop-up for checking whether a precondition related to a safe state of a user is satisfied or an input for changing the precondition, to control the at least one controller to operate in the virtual mode.

In an embodiment of the present disclosure, the processor may be configured to determine whether the updated function is an OTA software update for improving marketability of a vehicle, and the OTA software update includes at least one of a vehicle function, a user setting mode (USM) setting, or a cluster navigation design setting.

According to another embodiment of the present disclosure, a vehicle control method is provided. The vehicle control method includes checking, by a processor, an over-the-air (OTA) software update. The vehicle control method also includes detecting, by the processor, that a user experience has been selected for an updated function. The vehicle control method further includes mimicking, by the processor, a communication signal related to the updated function based on the selection. The vehicle control method additionally includes operating, by the processor, the updated function in a virtual mode using the mimicked communication signal.

In an embodiment of the present disclosure, the method may further include: mimicking, by the processor, at least one communication signal among a controller area network (CAN) signal and a CAN flexible data-rate (CAN FD) signal; and changing, by the processor, a signaling value of the mimicked communication signal.

In an embodiment of the present disclosure, the method may further include setting a signaling value of the mimicked communication signal to a value required for operating in the virtual mode. The value required to operate in the virtual mode may be set to a value that adaptively varies based on the updated function.

In an embodiment of the present disclosure, the method may further include transmitting, by the processor, a signaling transmission suspension request signal to suspend transmission of an actual signal corresponding to the mimicked communication signal.

In an embodiment of the present disclosure, the method may further include: generating, by the processor, an output request signal based on the mimicked communication signal and an input signal of another controller; and displaying, by the processor, a motion result of the virtual mode through the generated output request signal.

In an embodiment of the present disclosure, the method may further include receiving, by the processor, a feedback signal on the motion result of the virtual mode.

In an embodiment of the present disclosure, the method may further include controlling, by the processor, the updated function in the virtual mode based on a user input provided via switch manipulation or screen touch.

In an embodiment of the present disclosure, the method may further include checking, by the processor, a pop-up for checking whether a precondition related to a safe state of a user is satisfied or an input for changing the precondition, to operate the updated function in the virtual mode.

In an embodiment of the present disclosure, the method may further include determining, by the processor, whether the updated function is an OTA software update for improving marketability of the vehicle. The OTA software update may include at least one of a vehicle function, a user setting mode (USM) setting, or a cluster navigation design setting.

Embodiments of the present disclosure may provide an advantage of enhancing customer user experience and user satisfaction with new OTA update contents by allowing users to directly input and manipulate actual updated functions in a vehicle system that supports over-the-air (OTA) software updates and, as desired, virtually directly experience input for the corresponding functions through a virtual mode using controller area network (CAN) signal mimicry. Furthermore, embodiments of the present disclosure may reduce unnecessary visits to service centers, reduce overall vehicle operating costs, and suggest ways to improve eco-friendly services for society as a whole.

Furthermore, embodiments of the present disclosure may offer an advantage of displaying OTA update change history using various visualization elements and animations that consider user-friendly customer convenience, overcoming limitations of services that display OTA update change history in text-based letters. Furthermore, when experiencing the new functions in a vehicle, embodiments of the present disclosure may allow users to directly manipulate the new functions and experience the new functions visually, audibly, and tactilely, and provide a service environment that takes user safety into consideration by supporting a virtual mode for specific functions.

Furthermore, various effects that may be directly or indirectly identified through the present specification may be provided.

### BRIEF DESCRIPTION OF THE DRAWINGS

FIG. 1 illustrates a block diagram showing a configuration of an example vehicle system including a vehicle control apparatus, according to an embodiment of the present disclosure.

FIG. 2 schematically illustrates a configuration of an example vehicle communication control system, according to an embodiment of the present disclosure.

FIG. 3A and FIG. 3B illustrate an example of an OTA software update of a vehicle control apparatus, according to an embodiment of the present disclosure.

FIG. 4 illustrates an example of an OTA wireless update procedure of a vehicle control apparatus, according to an embodiment of the present disclosure.

FIGS. 5A to 5D illustrate examples of changes in details after completion of an OTA wireless update for a vehicle control apparatus, according to an embodiment of the present disclosure.

FIG. 6A and FIG. 6B illustrate a configuration of an example vehicle system performing an OTA wireless update, according to an embodiment of the present disclosure.

FIG. 7 illustrates a detailed configuration of an example virtual motion implementation logic of a vehicle control apparatus, according to an embodiment of the present disclosure.

FIG. 8 illustrates an example of a CAN signal configuration, according to an embodiment of the present disclosure.

FIG. 9A and FIG. 9B illustrate block diagrams conceptually showing a motion of implementing a virtual motion according to a user input, according to an embodiment of the present disclosure.

FIG. 10A and FIG. 10B illustrate block diagrams showing a detailed configuration of a system for performing virtual motion implementation, according to an embodiment of the present disclosure.

FIG. 11 illustrates a signal flowchart for performing virtual motion implementation of an example vehicle control apparatus, according to an embodiment of the present disclosure.

FIG. 12 illustrates an example computing system, according to an embodiment of the present disclosure.

### DETAILED DESCRIPTION

Hereinafter, some embodiments of the present disclosure are described in detail with reference to the accompanying drawings. It should be noted that in adding reference numerals to constituent elements of each drawing, the same constituent elements are designated by the same reference numerals as even when the elements are illustrated on different drawings. Furthermore, in describing embodiments of the present disclosure, where it was determined that detailed descriptions of related well-known configurations or functions would obscure the gist of the present disclosure, the detailed descriptions thereof will be omitted.

In describing constituent elements according to various embodiments of the present disclosure, terms such as first, second, A, B, (a), and (b) may be used. These terms are only used for distinguishing the constituent elements from other constituent elements, and the nature, sequences, or orders of the constituent elements are not limited by the terms. Furthermore, all terms used herein including technical scientific terms have the same meanings as those which are generally understood by those having ordinary skill in the technical field to which the present disclosure pertains, unless the terms are differently defined herein. Terms defined in a generally used dictionary should be construed to have meanings matching those in the context of related art, and should not be construed to have idealized or excessively formal meanings unless the terms are clearly defined in the present specification.

In the present disclosure, when a component, controller, device, element, server, apparatus, unit or the like of the present disclosure is described as having a purpose or performing an operation, function, or the like, the component, controller, device, element, server, apparatus, unit or the like should be considered herein as being “configured to” meet that purpose or to perform that operation or function. Each component, controller, device, element, server, apparatus, unit, server, and the like may separately embody or be included with a processor and a memory, such as a non-transitory computer readable media, as part of the apparatus.

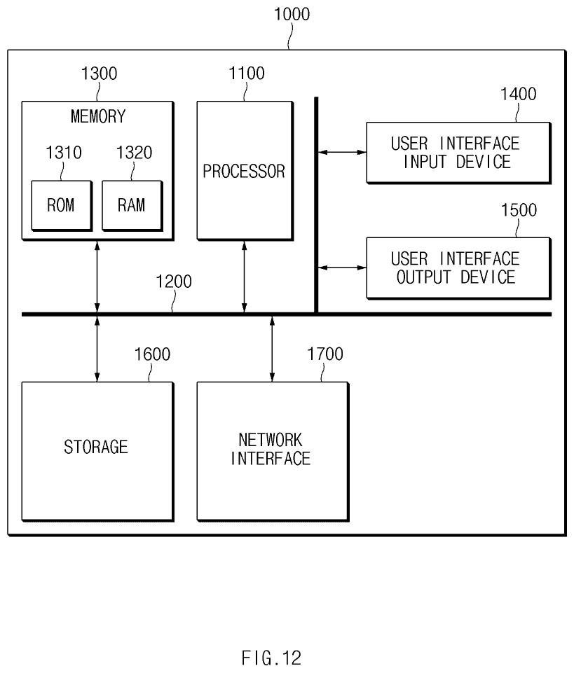

Hereinafter, various embodiments of the present disclosure are described in detail with reference to FIG. 12.

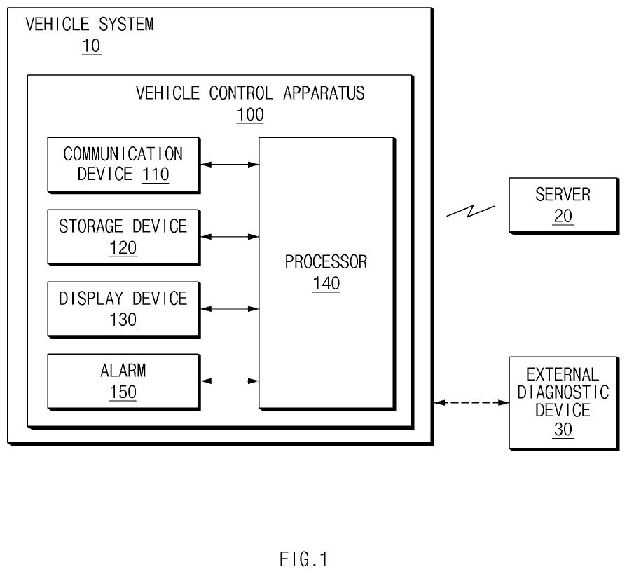

FIG. 1 illustrates a block diagram showing a configuration of an example vehicle system including a vehicle control apparatus, according to an embodiment.

Referring to FIG. 1, according to an embodiment of the present disclosure, the vehicle control apparatus 100 may be implemented inside the vehicle. For example, the vehicle control apparatus 100 may be integrally formed with internal control units of the vehicle, or may be implemented as a separate device to be connected to control units of the vehicle by a separate connection means. For example, the vehicle control apparatus 100 may include a transmission control device that integrally manages and controls various subsystems of a vehicle, such as a transmission, an engine, and a brake. Furthermore, the vehicle control apparatus 100 may be configured to support a navigation service, and may include a program that guides a path to a destination based on a current position of the vehicle. Furthermore, the vehicle control apparatus 100 may include an infotainment platform and system that provides an accurate path by utilizing a global positioning system (GPS) and map data, and provide an optimal path by reflecting real-time traffic information. The vehicle control apparatus 100 according to an embodiment of the present disclosure may be configured to integrally manage physical and digital elements, including a shift control device and an intrusion detection device, and may be integrally formed with control units that ensure safety and performance of the vehicle, or may be implemented as a separate device and connected to the control units of the vehicle.

The vehicle control device 100 according to an embodiment of the present disclosure may include a communication device 110, a storage 120, a display device 130, a processor 140, and an alarm 150.

The communication device 110 may be a hardware device implemented with various electronic circuits for transmitting and receiving signals through wireless or wired connections, and according to one embodiment of the present invention, may perform in-vehicle communication through CAN communication, CAN-FD communication, LIN communication, Ethernet communication, etc., and may include various communication units, such as a mobile communication unit, a broadcast receiving unit such as a DMB module or a DVB-H module, a short-range communication unit such as a Zigbee module, a Bluetooth module, or an NFC module, and a Wi-Fi communication unit, for communication with a server 20 and an external diagnostic device 30 outside the vehicle. In an embodiment, the CAN (controller area network) communication may be a vehicle network system developed to provide digital serial communication between various measuring and control devices within a vehicle, and a CAN data bus is used for data transmission and control between electronic control units (ECU).

Furthermore, the communication device 110 according to an embodiment of the present disclosure may perform bidirectional communication between a vehicle and surrounding vehicles, a vehicle and road infrastructure, and a vehicle and pedestrians, and may continuously share and transmit/receive data with all elements, including a host vehicle and surrounding vehicles. The communication device 110 may be configured as an integrated part of the vehicle or as a form allowing contact with a communication terminal, enabling inter-vehicle communication and vehicle-to-infrastructure communication, and autonomously performing navigation to a designated destination through vehicle sensors and driving control functions equipped in the vehicle.

In an embodiment, the vehicle sensors may include at least one of a global positioning system (GPS) sensor, a gyro sensor, or an acceleration sensor. The global positioning system (GPS) sensor, the gyroscope sensor, the acceleration sensor, etc. may measure the vehicle's position, movement, and orientation, and, in a case of being combined with other sensors in the vehicle, may support driving safety, autonomous driving, navigation, as well as vehicle tracking and management. In particular, the gyro sensor and the acceleration sensor may be combined with a LiDAR, a camera, and a radar to monitor the vehicle's position and attitude in real time, and the acceleration sensor and the gyro sensor may be combined to control the vehicle's rotation and acceleration. Furthermore, precise path tracking and real-time driving control for an autonomous vehicle may be achieved by tracking position through the GPS sensor, maintaining direction with the gyroscope sensor, and detecting movement changes using the accelerometer sensor.

Furthermore, environmental detection sensors for recognizing external surroundings may include a LiDAR that generates 3D terrain data around the vehicle using lasers; a Radar that measures a vehicle distance and speed using radio waves; an ultrasonic sensor that detects an objects at short distances (e.g., for a parking assistance system); and a camera sensor that supports lane-keeping, road sign recognition, and pedestrian detection. Various sensor fusion technologies may be applied for this purpose.

The communication device 110 may support a WAVE communication technique for a V2X communication function, and/or may support a next-generation communication technique including 3GPP-based LTE/NR/5G-Adv, and 6G. For example, supporting the NR access technology of the 5G system may enable enhanced mobile broadband (eMBB) of high-capacity data, minimization of terminal power consumption and massive machine-type communications (mMTC), as well as ultra-reliable and low-latency communications (URLLC).

The wireless communication module may support high frequency bands (e.g., mmWave bands) to achieve a high data transmission rate. Various technologies applied by the wireless communication module to ensure performance in high-frequency bands may include beamforming, massive multiple-input and multiple-output (MIMO), full dimensional MIMO (FD-MIMO), array antennas, analog beam-forming, and large-scale antennas. Furthermore, with advancement of next-generation communication technologies, newly proposed forms of AI/ML models may be utilized to support wireless communication modules capable of performing signal processing tasks such as channel estimation, equalization, and demapping. Accordingly, service optimization and data, channel estimation, etc. may be applied through a more efficient network air interface.

For example, the communication device 110 may support wireless access for vehicle environment (WAVE) communication and enable seamless communication between vehicles (V2V) as well as between vehicles and infrastructure (V 2I) by utilizing IEEE 802.11a wireless LAN technology. Accordingly, the communication device 110 may utilize a 10 MHz channel bandwidth in the 5.9 GHz band, support a maximum data rate of 27 Mbps, adopt CSMA/CA for wireless channel access, and be based on IEEE 802.11p for the physical layer while supporting upper layers using the IEEE 1609.x standard.

Furthermore, the communication device 110, according to an embodiment of the present disclosure, may support LTE V 2X (Rel. 14) based on the 3GPP system, as well as communication technologies including LTE eV 2X, 5G/5G-Adv, and 6G NR V2X. Broadly, V2X communication may include vehicle-to-vehicle (V2V) communication based on LTE/NR between vehicles, vehicle-to-pedestrian (V2P) communication based on LTE/NR between vehicles and terminals carried by individuals, and vehicle-to-infrastructure/network (V2I/N) communication based on LTE/NR between vehicles and roadside units or networks, and may be characterized by improved network scalability in V2I communication through the use of OFDMA wireless access. Furthermore, 5G NR, 5G-Adv, 6G, and next-generation communication systems may support advanced V2X services, such as sensor data sharing for autonomous vehicles and high-precision map updates, enabling ultra-low latency and high-reliability communication, and may include coexistence and interoperability with existing LTE V2X systems. Accordingly, it may be possible to improve the reliability, delay time, and throughput of vehicle communication, thereby supporting a safer and more efficient transportation system.

Furthermore, there may be no limitation on the multiple access technique of the wireless communication system to which the present disclosure is applied. For example, various multiple access techniques, such as code division multiple access (CDMA), time division multiple access (TDMA), frequency division multiple access (FDMA), orthogonal frequency division multiple access (OFDMA), single carrier-FDMA (SC-FDMA), OFDM-FDMA, OFDM-TDMA, and OFDM-CDMA, may be utilized. Furthermore, uplink transmission and downlink transmission may utilize a time division duplex (TDD) method, which transmits using different times, or a frequency division duplex (FDD) method, which transmits using different frequencies.

The storage 120 may download and store various service data for the vehicle received from the server 20 through the communication unit 110, as well as data for vehicle wireless updates. Accordingly, the storage 120 may verify information on the vehicle's position, road data, surrounding road infrastructure such as bus stops, and road environments through vehicle sensors and the server 20, and perform storage, management, and updates of such information. Furthermore, destination information set by a user, previously navigated paths, and real-time updated external traffic-related infrastructure data may be received and stored at predetermined intervals or based on configured services.

Furthermore, according to embodiments of the present disclosure, data from various input sensors supporting autonomous driving, road information, and communication information may be stored and managed through a server, which includes storing, managing, and updating data received from communication servers regarding road and traffic information, as well as data input through various sensors installed inside and outside the vehicle.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and/or an optical disk.

The display device 130, controlled by the processor 140, may present a screen to obtain user authentication approval for the vehicle's wireless update. The display device 130 may be implemented as a head-up display (HUD), a cluster, an audio video navigation (AVN), etc. Furthermore, the display device 130 may include at least one of a liquid crystal display (LCD), a thin film transistor-LCD (TFT LCD), a light emitting diode (LED) display, an organic light emitting diode (OLED) display, an active matrix OLED (AMOLED) display, a flexible display, a bended display, or a 3D display. Some of these displays may be implemented as a transparent display formed of a transparent or translucent type such that the outside can be viewed. In addition, the display device 130 may be provided as a touch screen including a touch panel, and may be used as an input device as well as an output device.

The processor 140 may be electrically connected to the communication device 110, the storage 120, the display device 130, an alarm device 150, and the like, may electrically control each component, and may be an electrical circuit that executes software commands, thereby performing various data processing and calculations described below. The processor 140 may be configured to support adaptive data processing and computation by applying a newly proposed new type of AL/ML model or by considering an internally implemented AL/ML model.

The alarm 150 may output a notification for approval to a user while the display device 130 presents a screen for obtaining the user's approval. Alternatively, or additionally, the alarm 150 and/or the display device 130 may provide various information for V2X services such as path resetting due to congestion, driving guidance such as congestion alarms, and traffic safety, as well as in-vehicle infotainment information.

The vehicle according to the present disclosure may be equipped with multiple electronic control units (ECUs) connected to internal and external communication systems, enhancing user safety and providing various convenience features. An ECU may be a module that performs various electronic control functions within a vehicle, and may include, e.g., an engine control module (ECM) that is responsible for optimizing and controlling engine performance, a transmission control module (TCM) that is responsible for managing the transmission, a brake module (BCM) that manages and controls the brake system, an airbag control unit (ACU) that controls the operation and management of airbags, and a body control module (BCM) that manages and controls body-related functions such as door locks and interior lighting.

To this end, a CAN data bus may support communication between ECUs in a vehicle, allowing the ECUs to exchange sensor data and commands in real time and comprehensively control various functions of the vehicle. Alternatively, FlexRay may be applied as a vehicle communication protocol. FlexRay may support data rates of up to 10 Mbps, and may implement redundancy or increase data throughput through two independent communication channels. Furthermore, FlexRay may use a TDMA method to apply time slot concept such that all nodes on the network may transmit data without collision, and may support ADAS and autonomous driving by sharing data required for autonomous driving determinations between ECUs. For example, data generated inside a vehicle via FlexRay may be transmitted to other vehicles or infrastructure via a 3GPP-based communications network.

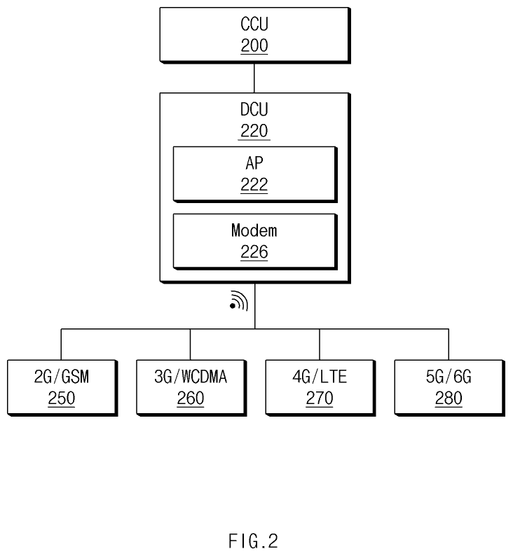

FIG. 2 schematically illustrates a configuration of an example vehicle communication control system, according to an embodiment.

Referring to FIG. 2, a communication control (CCU) 200 may be a communication control apparatus for a vehicle, and may be configured to include a central control apparatus that manages data communication between the vehicle's internal and external networks. Furthermore, the CCU 220 may be configured to provide connectivity between various ECUs and systems within the vehicle, and with external servers or cloud services. The CCU 200 according to an example of the present disclosure may be configured to support V2X communication (e.g., data exchange between vehicles (V2V), vehicle-to-infrastructure (V2I)), connected services (e.g., real-time navigation, remote diagnosis, and wireless software update (OTA, Over-the-Air) support), data gateway (e.g., a bridge role between protocols such as internal CAN, LIN, etc., and external LTE, 5G/5G-Adv, and 6G communications), and security management (e.g., data encryption and intrusion detection in a vehicle communication channel).

A domain control unit (DCU) 220 may be a control device that is configured to control and manage a specific domain (functional area) of a vehicle, and may be configured to efficiently control each domain (e.g., powertrain, body, infotainment, etc.) by integrating a number of distributed ECUs. For example, supporting ECU integration may reduce system complexity by consolidating the roles of multiple ECUs, thereby offering an advantage of reduced system operating costs. Furthermore, real-time data processing may support fast and accurate data handling, thereby enhancing autonomous driving and vehicle control functionalities. Applying a modular design approach may enable independent management for each domain, providing an advantage of easier maintenance. Furthermore, smart control may support high-performance computation and optimization in key vehicle domains (e.g., structure, electrical system). For example, a DCU may be configured to manage a vehicle's electric drive system to maximize battery efficiency, or manage an infotainment system to enhance user experience.

According to an example of the present disclosure, the CCU 200 may be configured to transmit and receive data through communication with an outside in an ignition on (IGN On) state (for example, a state in which the vehicle's electrical system is activated, the engine is ready to drive, and power is supplied to electronic devices or the ignition switch is turned on), and the DCU 220 may be configured to perform main control for a vehicle domain in the IGN On state. On the other hand, in an ignition off (IGN Off) state (for example, a state in which the vehicle's electrical system and engine are both disabled, the engine is turned off, and the ignition switch is turned off), the CCU 200 and DCU 220 may enter a low power mode to minimize battery usage and drive to perform basic maintenance functions.

In an embodiment of the present disclosure, the CCU 200 and the DCU 220 are described as separate units, but they may be integrated and configured within the vehicle and drive together with the IGN state to maximize efficiency and performance of the vehicle. According to an embodiment of the present disclosure, after the vehicle completes parking and the ignition is turned off, the vehicle may transition into a sleep mode. This may control an application (AP) area 222 of the DCU 220 to drive in the sleep mode and a modem area 226 to drive in an on state. In an embodiment, the modem-on state may refer to a condition where the vehicle is properly registered to the network and maintains a connection to next-generation wireless communication network systems, including a GSM 250, a WCDMA 260, an LTE 270, and a NR/5G-Adv/6G 280, based on a surrounding network environment.

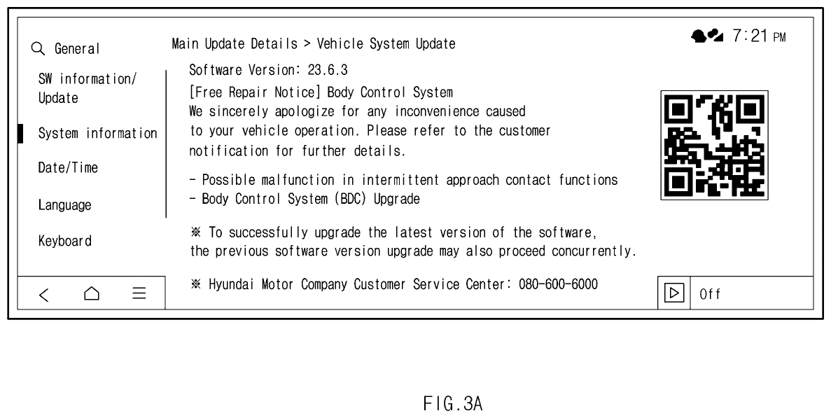

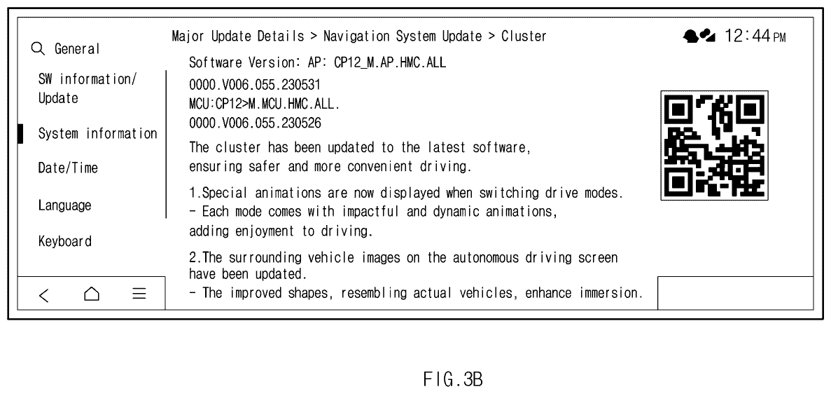

FIG. 3A and FIG. 3B illustrate an example of an OTA software update of a vehicle control apparatus, according to embodiments.

First, a vehicle control apparatus according to an embodiment of the present disclosure may support wireless software updates (over the air OTA)) for improving product quality in a vehicle. OTA indicates a technology that updates a vehicle's controller settings remotely via the Internet or wireless communication. This may allow the vehicle to have software errors corrected and new features added without having to visit a repair shop. The OTA may be applied to various network systems such as next-generation mobile communication (new radio) systems such as Wi-Fi, LTE, 5G, 5G-Adv, 6G, and NB-IoT. This may enable remote updates and automated updates for multiple ECUs within a vehicle. For example, manufacturers or operators may perform updates without users having to directly connect vehicle devices, and controllers in millions of vehicle devices may be updated remotely together. Furthermore, automatic updates are possible without a user manually downloading and installing them, and updates may be scheduled and distributed in stages.

Referring to FIG. 3A, after performing an OTA update for free repair (quality issue), main update details are displayed on a screen. Referring to FIG. 3B, after performing an OTA update for product improvement, main update details are displayed on a screen. The update details shown in FIG. 3A and FIG. 3B may be checked not only on the monitor screen but also via QR code. For example, the update details may be reviewed in detail for each free repair (OTA update) item, and may be verified through announcements and service record checks on a vehicle manufacturer's website or a user-friendly app.

A vehicle control apparatus according to an embodiment of the present disclosure may be configured to allow issues related to free repairs to be resolved without visiting a service center and support the advantage of swiftly providing and distributing functionality enhancements for required product value before a customer becomes aware

The OTA may provide continuous upgrades such as vehicle performance optimization, driving stability improvement, UI improvement, as well as simple error and issue fixes. In addition, the OTA updates may reduce unnecessary visits to service centers, thereby reducing overall vehicle driving costs and providing a direction for improving eco-friendly services.

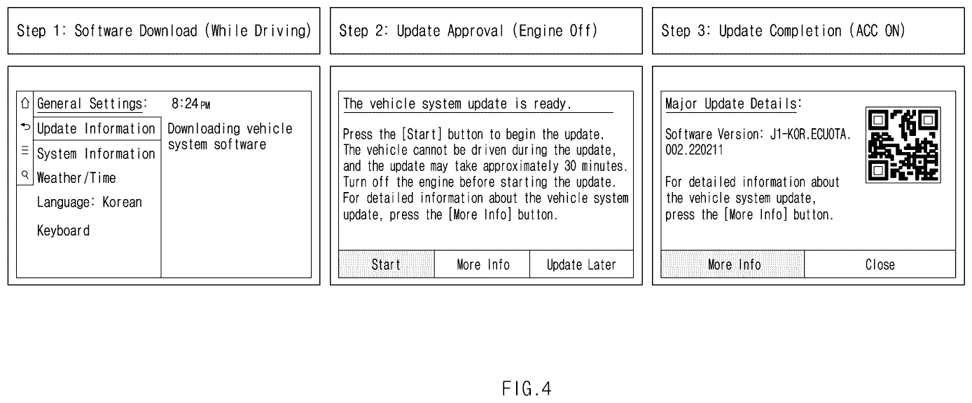

FIG. 4 illustrates an example of an OTA wireless update procedure of a vehicle control apparatus, according to an embodiment.

Referring to FIG. 4, Stage 1 is a software download phase, exemplified by the automatic download of required software files while the vehicle is in motion. The download progress may be checked in a vehicle's settings menu (e.g., Settings>General>Software Information/Update). A download time and timing may vary based on the vehicle model and network speed. Stage 2 is an update approval phase, exemplified by a case of the ignition being turned off. After the download of the software files is completed, a popup window for the update may be displayed in response to a case where the vehicle comes to a stop and the ignition is turned off. A user may then check the popup window to approve the update, enabling the installation of the downloaded file to proceed. Herein, in order to activate an installation button, fulfillment of following conditions may be determined. For example, the ignition-off state, parking brake engagement, gear in a P position, a hood closed, exterior lights turned off, and a sufficient battery level may be verified. This is to proceed with the update in a safer state with respect to the installation conditions. Furthermore, during an automated process, the download may proceed without user intervention, with installation exemplified by a simple approval; meanwhile, step-by-step intuitive guidance and condition settings may be implemented to ensure user-friendliness and vehicle stability. In Stage 3, upon the completion of the update (Acc ON), the vehicle system indicates the update completion through the display panel or a notification window. Accordingly, the user may check the update details, and detailed information may be accessed in the settings menu (e.g., Settings>System Information>Key Updates). Furthermore, for user convenience, a QR code may be provided, allowing a user to check detailed update information or receive assistance through the QR code. The completion of the update process may support services that ensure transparency regarding the update and clearly communicate changes to the user.

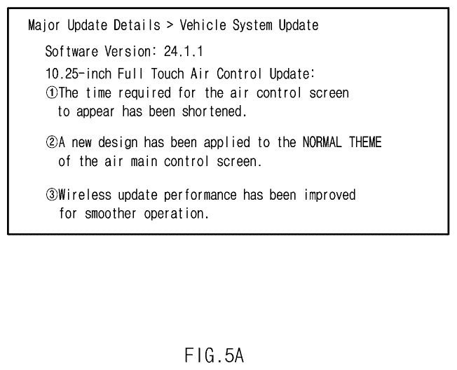

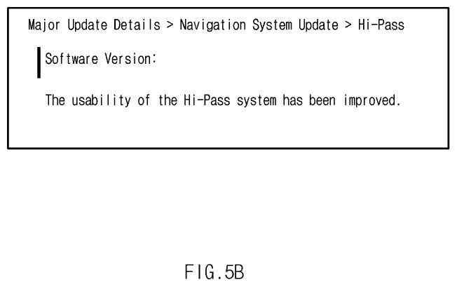

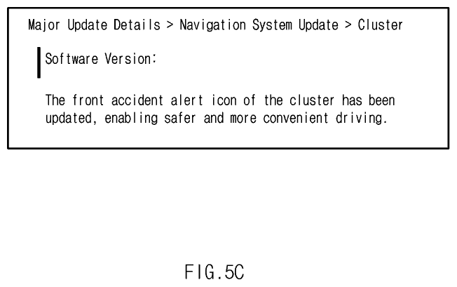

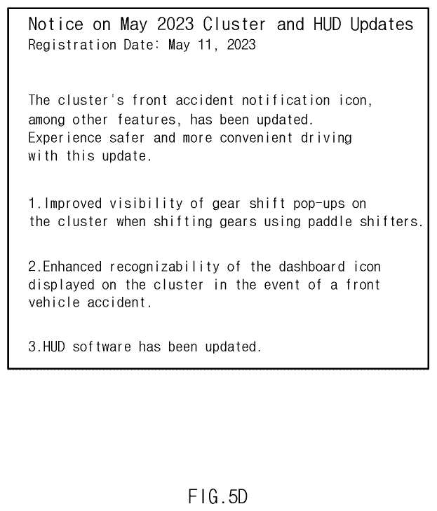

As described, after the OTA update is completed, the user may check the information via an in-vehicle monitor, a QR code, a vehicle manufacturer, or an automobile website. However, major changes may be summarized in text, so there may be a disadvantage in that it is difficult for the user to easily or accurately understand the changes. This will be described with reference to FIG. 5.

FIGS. 5A-D illustrate examples of changes in details after completion of an OTA wireless update for a vehicle control apparatus, according to embodiments.

FIGS. 5A-D illustrate examples of major update details being displayed on the vehicle's monitor screen or QR code, vehicle manufacturer, and automobile homepage after an OTA update is completed. In a case where the changed contents due to an OTA update are provided simply as text, it may be difficult for a user to directly experience or visually confirm the function. This may require a user to confirm which function has been updated in a user vehicle through an update description text and allow the user to anticipate its user, but in a case where the actual change is lengthy or includes specialized terminology, it may be challenging to comprehend text-based update details, whereas overly concise summaries risk omitting critical information. For this reason, the display of text-based update history has a disadvantage of being less user-friendly. Furthermore, text descriptions of new features provided to a user unfamiliar with vehicle functions may lead to difficulties and inconvenience in accessing these features, ultimately resulting in situations where the user struggles to properly understand operational methods and fails to utilize the features.

Furthermore, considering that OTA software updates are becoming increasingly important factors in improving product competitiveness and customer satisfaction by continuously improving vehicle functions, measures to further improve user experience and convenience may be expected to play an even more critical role in the future.

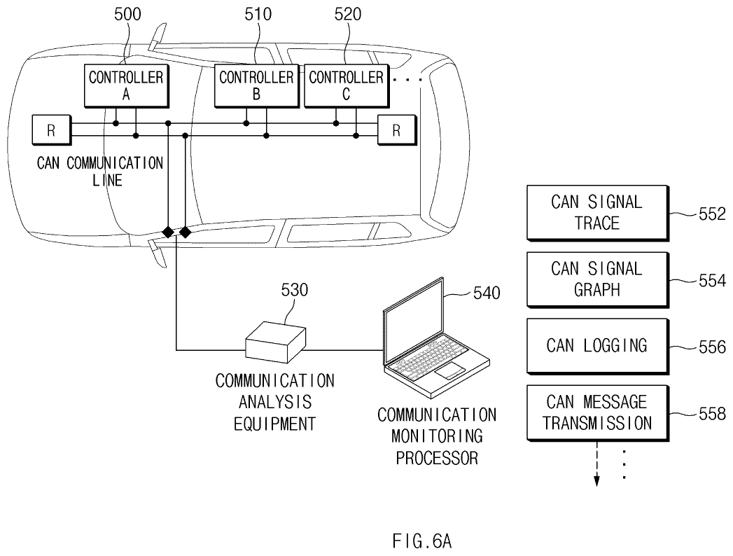

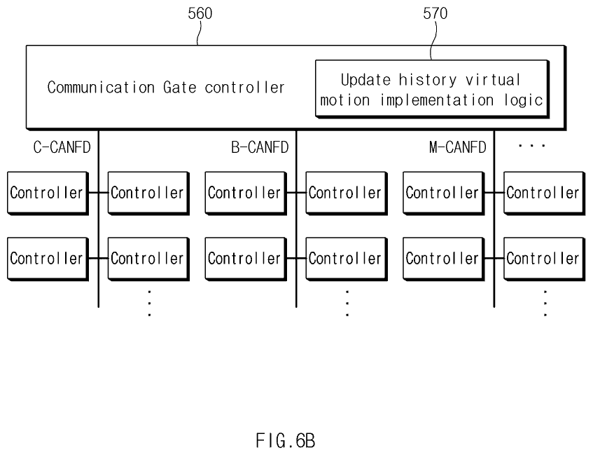

FIGS. 6A and B illustrate a configuration of an example vehicle system performing an OTA wireless update, according to an embodiment.

Referring to FIGS. 6A and B, a vehicle control apparatus according to an embodiment of the present disclosure may be configured to allow a user to virtually implement major update details in an actual vehicle after an OTA software update for improving product quality is performed in the vehicle, thereby enabling learning and utilization through simulation of what the updated function is, how it has changed, or how it drives. This may actively support user experience with new features and enhances customer satisfaction. The vehicle control apparatus according to an embodiment of the present disclosure may be configured to provide new functions (e.g., new driving functions, design of information within a cluster navigations (“cluster/navigation”) screen, a USM setting screen, etc.) to drive in order to provide better user experience and convenience to user customers. Hereinafter, with reference to FIG. 6A B, an example is provided to illustrate how a user may, after an OTA update is performed on the vehicle, more easily and actively verify the OTA update through attempts to use added features, recognition of improved menus, and interaction with a redesigned screen layout, according to an embodiment.

Referring to FIG. 6A, a system configuration diagram for analyzing a communication signal during a real vehicle evaluation is illustrated. The vehicle control apparatus according to an embodiment of the present disclosure may be configured to include a CAN communication monitoring system illustrated in FIG. 6. CAN communication may be a vehicle network protocol for transmitting and receiving data between electronic control units (ECUs) inside a vehicle, and the ECUs, e.g., Controller A 500, Controller B 510, and Controller C 520 may be connected to each other through a CAN communication line to transmit and receive data packets. In an embodiment, R represents a termination resistor (R) of the network, that prevents signal reflection and maintains stable communication. The controller A 500, the controller B 510, and the controller C 520 may each be responsible for various functions within the vehicle (e.g., engine control, brakes, steering, etc.) and may cooperate through the CAN communication to drive the vehicle control apparatus. A communication analysis equipment 530 may be a hardware device for analyzing CAN communication, and may capture messages transmitted and received on a network. For example, the communication analysis equipment 530 may check message monitoring, error diagnosis, and data logging. A communication monitoring processor 540 may be configured to include a device and processor that implements a software program that interprets and visually displays data captured from the communication analysis equipment 530, and support real-time confirmation of CAN signals inside the vehicle or diagnosis of problems.

For example, the communication monitoring processor 540 according to an embodiment of the present disclosure may be configured to perform a CAN signal trace function 552 and trace messages and communication signals transmitted and received in a CAN network, capture them in real time, and display them in a text form. In an example, the communication monitoring processor 540 may be possible to monitor the signal by checking an ID, data field, a transmission cycle, etc. of each message, and after an OTA software update according to an example of the present disclosure, tracking of major update history and monitoring of real-time information may be supported. Furthermore, a CAN signal graph function 554 may be supported to display or visualize an amount of change in a specific CAN signal in a form of a graph, thereby making it easier to understand an operating characteristic of the signal. Furthermore, through a CAN logging function 556, recording and storing CAN communication data may be supported for later analysis. This may be effectively utilized for identifying a time point at which an error occurred, analyzing past data, or verifying information related to the OTA update. Furthermore, a CAN message transmission function 558 may transmit user-defined messages to the network for use in testing and debugging. The communication monitoring processor 540 according to an embodiment of the present disclosure may be configured to read all communication signal DB files in a vehicle, display signal names, and utilize data obtained by receiving communication signals and graphing them during evaluation to analyze the status of the vehicle. Furthermore, as needed, a CAN signal in a database may be selectively chosen and controlled to mimic and reproduce the signal for transmission

Herein, mimicry may include meanings such as duplication or copy, and for convenience of description, these terms may be used interchangeably. The duplicated CAN signal may also be used to verify what action other controllers receiving it are cooperating to perform.

For example, the controller A 500 may transmit a signal that is received and utilized by the controller B 510. In an embodiment, Assuming the controller A 500 transmits a CAN signal FuelDrReleaseSwSta (0x0: Off/0x1: On), the communication monitoring processor 540 may be configured to copy the CAN message signal, arbitrarily modify its state to On or Off, and transmit it. The controller B 510 may be configured to receive the signal and perform subsequent motions. In an embodiment, FuelDrReleaseSwSta (0x0: Off /0x1: On) is a signal (variable) that represents a specific state of the vehicle system, indicating the release switch status related to the fuel door and is expressed as a digital signal. 0x0 (Off) indicates an inactive state of a fuel door release switch, while 0x1 (On) signifies an active state of the fuel door release switch. Accordingly, the vehicle's body control module (BCM) (e.g., controller A 500) or a corresponding ECU of another system (e.g., fuel system status display, warning light control, etc.) (e.g., controller B 510) may be configured to detect the signal to perform actions such as unlocking or opening the fuel door. Meanwhile, a collision may occur between the signals transmitted by the controller A 500 and the communication monitoring processor 540. For example, the controller A 500 may be configured to transmit an Off signal, and the communication monitoring processor 540 may be configured to transmit an On signal, which may result in the controller B 510 malfunctioning or failing to operate. Accordingly, in a case of transmitting an arbitrary signal for evaluation or verification, the communication monitoring processor 540 may be configured to control a CAN line or power of the controller A 500 to ensure validity of a signal transmitted from the communication monitoring processor 540, thereby facilitating evaluation.

FIG. 6B illustrates a schematic diagram conceptualizing a communication topology for performing a virtual motion implementation logic according to an embodiment of the present disclosure. The vehicle control apparatus according to an embodiment of the present disclosure may be configured to include a communication gateway controller 560 that routes signals between separate communication channels, such as chassis, body, multimedia, powertrain, and autonomous driving, with controllers connected to each channel. The communication gateway controller 560 may be configured to perform a role of delivering and routing data between controllers connected to each communication channel, transferring data from a specific channel to other necessary channels (data routing) and enabling protocol conversion (e.g., CAN↔Ethernet) to support data transformation between different communication protocols. That is, each functional area (chassis, body, multimedia, etc.) operates independently, while being able to interact with each other through the communication gateway controller 560. Furthermore, the communication gateway controller 560 may be configured to perform authentication and encryption of communication data, fulfilling a role of security management, and carries out a data filtering function eliminating unnecessary data and prioritizing transmission of essential data. This may allow all data flow within the vehicle to be controlled and managed. For example, the autonomous driving system's LiDAR, camera, and radar sensors collect environmental data, and the collected sensor data can be transmitted to the autonomous driving ECU within the vehicle through Ethernet via the communication gateway controller 560. Furthermore, navigation or multimedia data may be transmitted to a multimedia channel through the communication gateway controller 560. Accordingly, an autonomous driving path within the vehicle may be transmitted to the display controller to be displayed on a screen. Furthermore, the communication gateway controller 560 may be configured to serve a role of protecting an internal vehicle network from an external network (an OTA update and V2X communication).

Considering that the OTA update is performed in real time according to the present disclosure, the communication gateway controller 560 may be configured to perform data authentication and encryption, thereby preventing hacking of the vehicle. Furthermore, firmware of all ECUs may be managed for a software update according to the present disclosure. Furthermore, the communication gateway controller 560 may be configured to include an update history virtual motion implementation logic 570 to selectively select a CAN signal and transmit the signal by simulating the signal. This may allow the vehicle control system according to an embodiment of the present disclosure to assist a user in learning and utilizing items listed in major update details after the OTA update through simulation via the virtual motion implementation logic 570, and in a case where a manipulation is input by the user in a vehicle state, a corresponding communication signal may be duplicated and transmitted, enabling other associated controllers to receive the signal and activate a function,

In an embodiment, the communication gateway controller 560 may be configured to include CAN FD (flexible data-rate), which provides a higher data transmission speed and efficiency through a CAN signal.

The CAN FD may support faster transmission speeds than that of existing CAN, while maintaining compatibility with a CAN network. C-CANFD, B-CANFD, and M-CANFD may represent classifications of CAN FD networks within the vehicle, designated for specific purposes, with each CAN FD network differentiated based on various functions and requirements within the vehicle. For example, C-CANFD may be a CAN FD network used in the vehicle's chassis system, responsible for driving stability and safety, with an emphasis on real-time performance and reliability. Accordingly, data packet loss and delay may have to be minimized. B-CANFD may be a CAN FD network used in the vehicle's body system, controlling functions related to vehicle convenience, including door locking/unlocking, window opening/closing, external lighting control (headlamps and taillamps), air conditioning, heater, blower control, and seat control. This may constitute majority of the vehicle, making it essential to take network cost efficiency into account. M-CANFD may be a CAN FD network used in the vehicle's multimedia and infotainment systems, processing data related to various functions that enhance a user experience UX of the vehicle. For example, in relation to infotainment systems, M-CANFD may be used for audio, video, navigation, and streaming services, as well as for digital clusters and head-up display (HUD) to display driving information, warning messages, and theme changes, along with rear cameras, surround views, and driver monitoring. M-CANFD may handle large-scale data processing for high-resolution displays and multimedia content transmission, requiring low-latency data transfer for real-time performance in video playback and audio synchronization. Furthermore, M-CANFD may support high-speed data transfer at a high bandwidth to ensure a seamless user experience.

As described, the vehicle control apparatus according to an embodiment of the present disclosure may be configured to include the communication gateway controller 560 featuring virtual motion implementation logic 570 that enables the user to directly perform motions such as switch manipulation and screen touch interactions regarding an OTA update content, supporting the user in verifying actual outputs and experiencing (learning) new functions. The vehicle control apparatus according to an embodiment of the present disclosure may be configured to include a virtual input device that transmits simulated CAN signal inputs through the virtual motion implementation logic 570, mimicking the user's actual manipulation on input devices or messages and signals of specific controllers. In an embodiment, the input device and the virtual input device may be implemented as a logically distinct module, or an independent input module may be implemented to be driven for convenience of the user. Through this, the vehicle control system according to an embodiment of the present disclosure may be configured to operate and verify update history features via driving of internal vehicle logic and actual or virtual outputs, enhancing services for direct user experience (learning), which may aid in understanding the update content and subsequently fosters more proactive user convenience, thereby improving customer satisfaction.

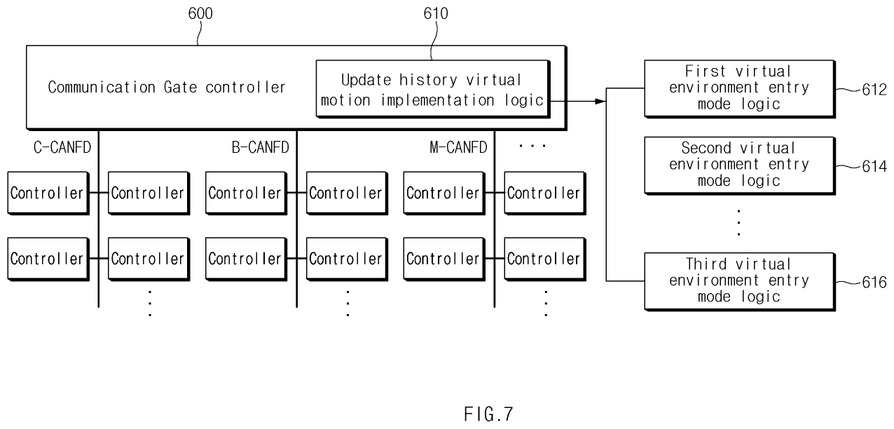

FIG. 7 illustrates a detailed configuration of an example virtual motion implementation logic of a vehicle control apparatus, according to an embodiment.

Referring to FIG. 7, a virtual motion implementation logic 610 according to an embodiment of the present disclosure may implement an arbitrary virtual environment entry mode upon selecting the corresponding item from an update history after an OTA update. To ensure that a CAN signal transmitted from the virtual motion implementation logic drives validly, transmission of the CAN signal from a controller in the actual vehicle may be stopped. This is because, as described above, in a case where continuous CAN transmission is being performed from the vehicle controller, a collision may occur between CAN signals transmitted in a virtual environment, which may result in abnormal driving. This motion may be performed in a first virtual environment entry mode logic 612.

Furthermore, to perform a corresponding function in the update history, a CAN signal for the corresponding function may be transmitted to any virtual environment entry mode in the virtual environment. The CAN signal transmitted virtually may mimic the original controller's message::signal while modifying a signal value to a desired value for transmission. This motion may be performed in a second virtual environment entry mode logic 614. Accordingly, the controller of any virtual environment entry mode that has received the corresponding CAN signal may drive the corresponding function. Through this, the communication monitoring processor 540 may be configured to monitor whether an input-control-output process is performed normally and visualize a result of the corresponding function in various forms, such as guidance messages and graphs, on a vehicle monitoring screen. Display driving for the virtual mode may be performed via a third virtual environment entry mode logic 616. In an embodiment of the present disclosure, the first virtual environment entry mode logic 612 and the third virtual environment entry mode logic 616 are described as driving in distinct units according to each motion, but the logics may be driven in logically distinct software forms within one same module, or may include operating according to each independent program.

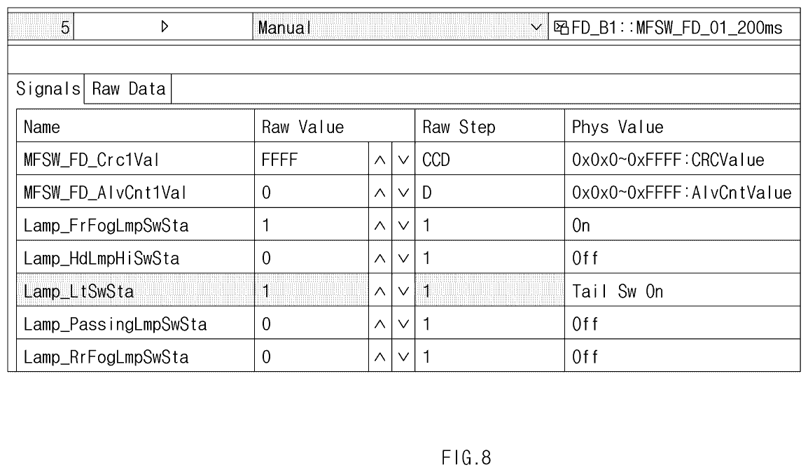

FIG. 8 illustrates an example of a CAN signal configuration, according to an embodiment.

FIG. 8 illustrates a CAN data signal analysis screen captured in software for analyzing vehicle communication data by the communication monitoring processor 540. The screen shows CAN messages and signals transmitted and received in a vehicle. For example, a message called MFSW_FD_01_200ms may contain multiple signals, such as the Lamp_LtSwSta signal. A name of each data field may be indicated through a signal name field of the CAN message. For example, Lamp_LtSwSta may represent a vehicle lamp switch status. A raw value field may display a raw data value (hexadecimal (FFFF) or binary (0/1)) in the CAN message, which contains an actual value within a data frame exchanged in a case of communicating between controllers (ECUs). The raw step field may represent a step-by-step data value into which a raw value was converted, and display a result in a case where a message is decoded. A Phys Value (physical value) field may include a value converted from a raw value into its actual physical meaning, representing a true state of the data and expressed in a way that makes it understandable to a user. For example, 1→Tail Sw On for Lamp_LtSwSta indicates that a tail lamp switch is turned on.

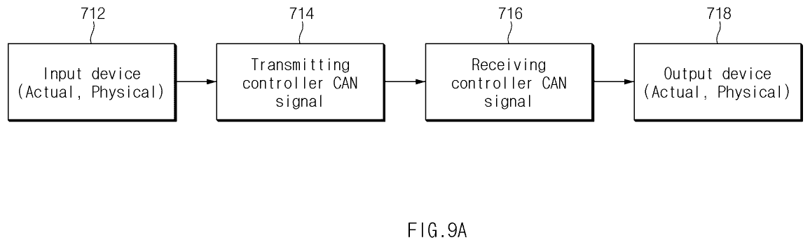

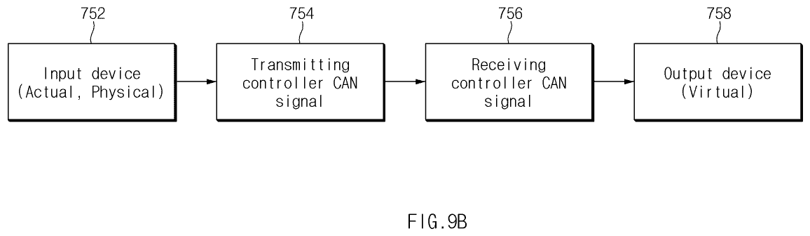

Accordingly, the communication monitoring processor 540 may be configured to utilize the corresponding CAN message::signal to implement an updated functional motion in a virtual environment. For example, by physically manipulating a multi-function switch to move it to a tail position, a multi-function controller may be configured to transmit MFSW_FD_01_200ms::Lamp_LtSwSta==0x1, and the lamp controller receiving the CAN signal may be configured to activate a tail lamp. In an embodiment, for implementation of virtual motion, upon receiving manipulation of the multi-function switch as an input, actual manipulation of the multi-function switch may be bypassed, and through the virtual motion implementation logic 570 (or 610), a signal value may be modified by simulating Lamp_LtSwStat==0x1, and the modified signaling value may be included in the simulated signal that is transmitted. The controller receiving the tail lamp signal may be configured to process signal to perform the corresponding motion. Hereinafter, a motion of the virtual motion implementation logic, according to an embodiment, is described in more detail with reference to FIGS. 9A and B.

FIGS. 9A and B illustrate block diagrams conceptually showing a motion of implementing a virtual motion according to a user input, according to an embodiment.

FIG. 9A illustrates a case where a user manipulates input and an actual motion is confirmed in a vehicle, and FIG. 9B illustrates a case where a user manipulates input but the actual motion is not confirmed in the vehicle. The following descriptions exclude contents in which functions are improved through manipulations that are not recognized by a user and related to quality improvement, or improvements in an output function that is not recognized by the user. For example, a functional improvement such as ‘enhancing output at a specific speed by modifying engine logic’ may be an automatically executed logic that does not require user learning, and accordingly may be unrelated to user learning of new update details. In an embodiment, functional improvements triggered by specific input actions (such as switches or USM) resulting in output changes (such as actual motions or graphical displays) may include outputs that occur during the user's manipulating process for learning, allowing the user to perceive the output, but there may also be features where actual output may not occur during the user's manipulating process for learning and requires additional conditions, such as driving, to verify the output.

Referring to FIG. 9A, learning application of new animations for COMFORT, SPORT, and SMART modes activated by pressing a drive mode switch 712 may allow the user to press a drive mode switch and observe mode-specific animation effects directly on actual cluster controllers 714 and 716. In an embodiment, the user may check the output through an actual cluster screen 718 in the vehicle. Referring to FIG. 9B, learning a function of increasing an inter-vehicle distance from Level 3 to Level 5 during smart cruise driving involves the user being able to adjust the inter-vehicle distance switch, but actual adjustment of a distance between the vehicle and the preceding vehicle may be verified in an actual driving mode. Accordingly, the inter-vehicle distance setting may not confirm the actual gap in a case where the vehicle is stopped (P gear). Thus, according to an embodiment of the present disclosure, the virtual motion implementation logic may provide a user experience through a motion logic of the virtual mode, allowing the user to learn new features (e.g., 5-level settings) in a stationary state (P gear) or non-start state (IG ON). Accordingly, in a case where the user manipulates an input device 752 (e.g., predetermined switch for inter-vehicle distance) to generate an input signal, the input signal may be actually transmitted to a vehicle controller or to a virtual simulation environment. A CAN network signal may be generated based on switch input data transmitted from the input device 752, and thus in a virtual mode, the controller 754 (CAN signal transmission) may be configured to generate a mimicked CAN signal to support simulation as if the actual vehicle is in a driving state. Accordingly, a controller 756 (e.g., smart cruise controller) may be configured to receive the generated CAN signal, interpret the signal, and recognize that the vehicle is driving in a Not P state. An output device 758 may mimic the CAN signal in a virtual environment to display a motion logic experience as a simulation result on a display or cluster. For example, a gap graphic may be animated with the text “The gap level has changed based on the virtual mode.”

Furthermore, considering that the user may not see the actual output from the vehicle, implementation of the actual function may be controlled to be displayed instead of a guidance text pop-up or graphics. In an embodiment, the user may learn newly updated contents in a pre-condition satisfied state such as stopped, P (parking) gear, B+ (direct power from the battery), or IG ON (non-starting). For example, the actual vehicle state may be P, but a specific new function may be driven in Not P (e.g., R (reverse), N (neutral), D (drive), M (manual mode). To this end, in the virtual mode, the CAN signal may be mimicked and sent as a Not P signal to a receiving controller in the virtual operation logic, and the receiving controller may then recognize the Not P state and perform an output motion. The actual vehicle state may be implemented to be P-stage, and in virtual motion implementation may be implemented as Not P-stage. According to an embodiment of the present disclosure, a virtual mode implementation may be implemented so that a new function may be understood even in a stationary state, thereby improving a user experience. This may enhance safety by enabling a user to learn functions without risk factors while driving through prior user experience, and provide an advantage of being able to verify control logic through virtual simulation during a development phase. Furthermore, in a case of verifying main details of an OTA update, instead of reading and understanding text-based information, a user may perform a direct input motion required to activate a corresponding function, or for an input that is unable to be directly manipulated, a virtual CAN signal mimicry may be applied, and a result may be displayed through a guidance message on the screen, providing a advantage of actively enhancing convenience and efficiency of a user experience (learning).

According to an embodiment of the present disclosure, by utilizing CAN signal mimicry and a controller motion simulation through implementation of a virtual mode, a user may learn a function in a safer environment, thereby maximizing utility of a vehicle control system.

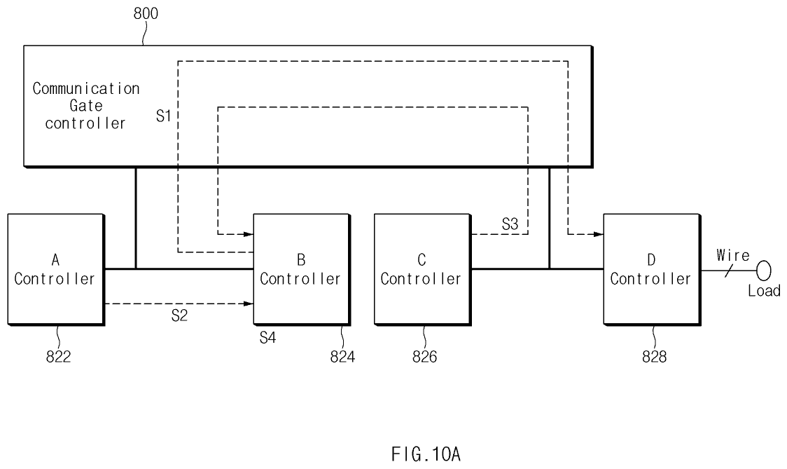

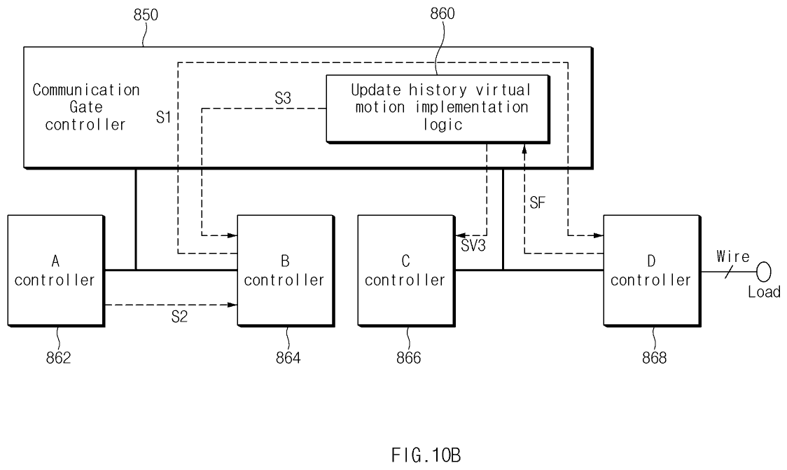

FIGS. 10A and B illustrate block diagrams showing a detailed configuration of a system for performing virtual motion implementation, according to am embodiment.

FIG. 10A schematically illustrates a flow of a CAN communication signal. Referring to FIG. 10A, the system for performing virtual motion implementation may include a controller A 822 configured to transmit switch inputs, a controller B 824 configured to process input integration and output requests, a controller C 826 configured to transmit sensor signals, and a controller D 828 configured receive output request signals and process the outputs. For example, describing a function where a multi-function switch is in an Auto position and, under a daytime condition, wiper working automatically activates a headlamp, the controller A 822 may be configured to transmit a signal S2 (switch state transmission: Lamp_LtSwSta==Auto/Wiper_FrWiperSwSta==Not Off) to the controller B 824. The controller C 826 may be configured to transmit a signal S3 (sensor status (AutolightSnsr==Day)) to the controller B 824. Accordingly, the controller B 824 may be configured to synthesize and determine the inputs based on the received signals, processing the output request signal S1 ({headlamp activation request (HdLmpLoOnReq==ON)}) and transmitting it to the controller D (828) under a condition where a sensor status (AutolightSnsr==Day), a lamp switch status (Lamp_LtSwSta==Auto), and a wiper switch status (Wiper_FrWiperSwSta==Not Off) are met.

Accordingly, referring to FIG. 10B, an update history virtual motion implementation logic 860 according to an embodiment of the present disclosure may transmit a CAN transmission suspension request signal to the controller C 866, which holds a message to be mimicked, thereby requesting CAN transmission suspension (SV3). For example, the CAN transmission suspension (SV3) signal may control suspension of communication transmission to the controller C 866 by considering a motion where a signal is continuously sent as Day under a daytime condition or Night under a nighttime condition, or a case where a Day condition is required despite an actual nighttime condition for learning experiences of update history during nighttime, and the virtual motion implementation logic 860 may generate the corresponding signal (mimicry of controller C's message::signal) and set the signal value to Day for transmission (S3). In the instant case, the controller D 868, that processes an output request transmitted from the controller B 864, may be configured to provide a feedback (SF) signal corresponding to a virtual mode to the update history virtual motion implementation logic 860, enabling the virtual motion implementation logic 860 to more efficiently transmit sensor signals for the controller C 866 and the controller B 864. The controller D 868 may be configured to receive an output request signal from the controller B 864 and provide a user with an output result for a virtual mode. The virtual motion implementation logic 860 may receive a signal feedback (SF) transmitted after normal output from the controller D 868 and use the signal feedback (SF) for normal/abnormal motion monitoring, such as displaying text on a vehicle monitor and providing voice support. Accordingly, the vehicle control apparatus according to an embodiment of the present disclosure may be configured to predict certain potentially conflicting CAN signals within the vehicle and preemptively control suspension of CAN signal transmission and the transmission of mimicked CAN signals, enabling safer provision of a guidance pop-up regarding a progress and process of the corresponding function.

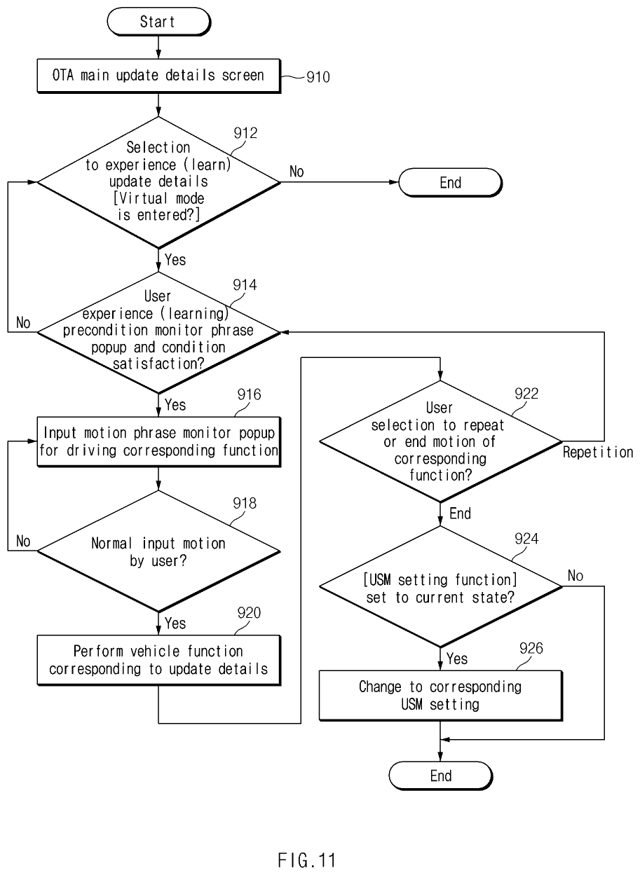

FIG. 11 illustrates a signal flowchart for performing virtual motion implementation of an example vehicle control apparatus, according to an embodiment.

Referring to FIG. 11, after the OTA update is completed, in an operation 910, the processor may be configured to check OTA main update details through the vehicle monitor screen. In an embodiment, a user may read the update details expressed in text and simply exit (in the case of operation 912, N) or click on the item to check what the actual OTA updated function is and experience (learn) the actual updated function motion in the vehicle (in the case of operation 912, Yes). In an embodiment, learning through actual functional motion is exemplified by experiences within the vehicle, but this may also include an ability to experience a same virtual mode as being seated in the vehicle, even in a space outside the vehicle. Furthermore, the virtual mode according to one embodiment of the present disclosure may include or require an operation 914 of a pop-up for checking whether a precondition is satisfied and a user changing a motion to satisfy the precondition, as a function implementation for an updated function in a safe state of the user. Furthermore, rather than addressing a quality OTA update that handles input-control-output within internal logic for quality improvement, in a case where the OTA update focuses on enhancing vehicle marketability, it may be typically described assuming a case where a user input, such as a switch (physical, touchscreen) or a USM setting, is required for an OTA update function, but this may also include a scenario where a virtual input value is transmitted for features that do not require the user input, enabling subsequent processes to proceed.

In an operation 916, the processor may provide a pop-up message with guidance for a user input motion for driving the OTA update function. Accordingly, the processor, aiming to enhance user experience (e.g., learning), may be configured to verify a direct motion input by the user related to a switch (physical, touchscreen) and a USM setting in an operation 918, and may perform vehicle function motions corresponding to the update details in an operation 920. In an embodiment, the processor, in relation to the virtual mode motion, may be configured to transmit a CAN transmission suspension request signal to a controller that originally transmits an input related to the corresponding function, and an input processing controller may be configured to control CAN transmission to temporarily suspend upon receiving the CAN transmission suspension request signal. Furthermore, the virtual motion implementation logic may be controlled to mimic and transmit a message::signal related to the original function. Accordingly, a control processor implementing the function may be configured to synthesize mimicked input signals and, in a necessary case, input signals from other controllers to transmit an output request signal, while an output processor may be configured to perform a control motion to display a result implemented in the virtual mode as an output.

This processor according to the present disclosure may be configured to implement a virtual motion implementation logic for vehicle product improvement OTA update history inside a gateway controller, thereby enabling a user to actually experience (learn) an OTA update function through a virtual mode. In the instant case, the processor may be configured to implement the virtual motion implementation logic to send a CAN signal transmission suspension request signal to the input controller in consideration of the virtual motion implementation mode, and thus the input controller may be configured to suspend CAN signal transmission in the virtual mode to prevent a CAN signal collision between controllers. Furthermore, input data values (input values due to event occurrence, input values transmitted periodically), etc. transmitted from all controllers may be checked to control the virtual motion implementation logic to mimic a corresponding message::signal and transmit it by setting it to a value required in a virtual motion, and for example, it may be possible to control implementation of a function in a virtual mode by sending a message::signal that mimics any input state that is actually OFF as ON. For example, in a case where a vehicle speed value is ‘0 km/h’, the signal may be set to transmit the input speed value as ‘15 km/h’ in the mimicked message::signal to allow the user to experience the best functionality of the updated feature in the virtual mode. This may include an ability to set variable signal settings that consider factors such as a user age, a driving habit, and a health status, in consideration of V2X technology and AI technology.

After the corresponding function according to the virtual mode is completed, the processor may be configured to provide, in an operation 922, a pop-up menu to enable the user to choose to perform the function again or terminate the function. In an operation 924, the processor may determine whether the function is due to a change in a USM setting. For example, in a case of determining a change in the USM setting, a menu may be displayed in a pop-up window for selecting whether to revert to the original USM setting or change to the USM setting after the user experience, and in a case where it is confirmed that the user has selected the corresponding USM setting function (924, in a case of Yes), the changed USM setting may be applied thereafter in an operation 926. Accordingly, the processor may be configured to ensure that a vehicle function, user setting mode (USM) setting, and cluster/navigation design setting are consistently maintained up to date, in consideration of a user input for a setting function.

As described above, the vehicle control apparatus according to an example of the present disclosure may be configured to support a more intuitive and improved user experience service for the OTA update function in a vehicle that is expected to implement increasingly diverse forms of user services by being integrated with AI and V2X technologies. This may be to support an OTA update service for not only OTA update contents to improve software quality issues in vehicles, but also functions to improve product quality to always provide a service environment like a new vehicle, thereby improving customer satisfaction. For example, it may be possible to provide a display that utilizes various visualization elements and animations that consider user-friendly customer convenience, going beyond the service limitations of only displaying OTA update change history in text-based letters, and provide a user-friendly service environment through virtual mode. Accordingly, when experiencing new functions in a vehicle, it may be possible to support a user in directly manipulating them and experiencing them visually, audibly, and tactilely, and this approach may enhance convenience by allowing the user to directly engage with functions that offer improved marketability, achieved through the support of a virtual mode for specific functions to prioritize user safety. This may provide an advantage of enhancing customer experience and user satisfaction with new OTA update details by allowing a user to experience direct input manipulation of actual updated functions and, in a necessary case, inputting the corresponding functions in a virtual mode through CAN signal simulation.

FIG. 12 illustrates an example computing system, according to an embodiment.

Referring to FIG. 12, a computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) and a random access memory (RAM).

Accordingly, steps of a method or algorithm described in connection with embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

A storage medium is coupled to the processor 1600. The processor 1100 may read information from and write information to the storage medium 1600. Alternatively, the storage medium 1600 may be integrated with the processor 1100. The processor 1100 and the storage medium 1600 may reside within an application specific IC (ASIC). The ASIC may reside within a user terminal. Alternatively, the processor 1100 and the storage medium 1600 may reside as separate components within the user terminal.

The above description is merely illustrative of the technical idea of the present disclosure, and those having ordinary skill in the art to which the present disclosure pertains may make various modifications and variations without departing from the essential characteristics of the present disclosure.

Therefore, the embodiments described in the present specification are not intended to limit the technical ideas of the present disclosure, but to explain them, and the scope of the technical ideas of the present disclosure is not limited by the describes embodiments. The protection range of the present disclosure should be interpreted by the claims below, and all technical ideas within the equivalent range should be interpreted as being included in the scope of the present disclosure.

What is claimed is:

1. A vehicle control apparatus comprising:
a processor configured to:
check an over-the-air (OTA) software update,
detect that a user experience is selected for an updated function,
mimic a communication signal transmitted to at least one controller related to the updated function based on the selection, and
control the at least one controller to operate in a virtual mode using the mimicked communication signal,
wherein the at least one controller is configured to receive the mimicked communication signal and operate in the virtual mode under control of the processor.

2. The vehicle control apparatus of claim 1, wherein the processor is configured to implement a virtual motion implementation logic configured to mimic at least one communication signal among a controller area network (CAN) signal and a CAN flexible data-rate (CAN FD) signal and change a signaling value of the mimicked communication signal.

3. The vehicle control apparatus of claim 1, wherein the processor is configured to set a signaling value of the mimicked communication signal to a value required to operate in the virtual mode, and
wherein the value required to operate in the virtual mode is set to a value that adaptively varies based on the updated function.

4. The vehicle control apparatus of claim 2, wherein the virtual motion implementation logic is configured to transmit a signaling transmission suspension request signal to the at least one controller to suspend transmission of an actual signal corresponding to the mimicked communication signal.

5. The vehicle control apparatus of claim 4, wherein the at least one controller is configured to suspend transmission of the actual signal upon receiving the signaling transmission suspension request signal.

6. The vehicle control apparatus of claim 2, wherein the virtual motion implementation logic is configured to:
generate an output request signal based on the mimicked communication signal and an input signal of another controller; and
transmit the output request signal to an output processor to control display of a motion result of the virtual mode.

7. The vehicle control apparatus of claim 6, wherein the virtual motion implementation logic is configured to receive a feedback signal (SF) indicating a motion result of the virtual mode from the output processor.

8. The vehicle control apparatus of claim 2, further comprising a communication gateway controller configured to perform data transmission and a routing motion of a control period and including the at least one controller, wherein the routing motion includes a protocol conversion motion for transmitting data of a specific channel to another channel.

9. The vehicle control apparatus of claim 1, wherein the processor is configured to control the updated function in the virtual mode based on user input provided via switch manipulation or screen touch input.

10. The vehicle control apparatus of claim 1, wherein the processor is configured to check a pop-up for checking whether a precondition related to a safe state of a user is satisfied or an input for changing the precondition, to control the at least one controller to operate in the virtual mode.

11. The vehicle control apparatus of claim 1, wherein the processor is configured to determine whether the updated function is an OTA software update for improving marketability of a vehicle, and
wherein the OTA software update includes at least one of a vehicle function, a user setting mode (USM) setting, or a cluster navigation design setting.

12. A vehicle control method comprising:
checking, by a processor, an over-the-air (OTA) software update;
detecting, by the processor, that a user experience has been selected for an updated function;
mimicking, by the processor, a communication signal related to the updated function based on the selection; and
operating, by the processor, the updated function in a virtual mode using the mimicked communication signal.

13. The vehicle control method of claim 12, wherein mimicking the communication signal includes:
mimicking, by the processor, at least one communication signal among a controller area network (CAN) signal and a CAN flexible data-rate (CAN FD) signal; and
changing, by the processor, a signaling value of the mimicked communication signal.

14. The vehicle control method of claim 12, wherein mimicking the communication signal includes setting a signaling value of the mimicked communication signal to a value required for operating in the virtual mode, and
wherein the value required to operate in the virtual mode is set to a value that adaptively varies based on the updated function.

15. The vehicle control method of claim 12, further comprising transmitting, by the processor, a signaling transmission suspension request signal to suspend transmission of an actual signal corresponding to the mimicked communication signal.

16. The vehicle control method of claim 15, further comprising:
generating, by the processor, an output request signal based on the mimicked communication signal and an input signal of another controller; and
displaying, by the processor, a motion result of the virtual mode through the output request signal.

17. The vehicle control method of claim 16, further comprising receiving, by the processor, a feedback signal on the motion result of the virtual mode.

18. The vehicle control method of claim 12, further comprising controlling, by the processor, the updated function in the virtual mode based on user input provided via switch manipulation or screen touch.

19. The vehicle control method of claim 12, further comprising checking, by the processor, a pop-up for checking whether a precondition related to a safe state of a user is satisfied or an input for changing the precondition, to operate the updated function in the virtual mode.

20. The vehicle control method of claim 12, further comprising determining, by the processor, whether the updated function is an OTA software update for improving marketability of a vehicle, wherein the OTA software update includes at least one of a vehicle function, a user setting mode (USM) setting, or a cluster navigation design setting.
